(19) United States
(12) Patent Application Publication
(10) Pub. No.: US 2007/0289637 A1
(43) Pub. Date: Dec. 20, 2007

(54) Valve Wheel Lockup Device

(76) Inventor: Earl Gordon, Calgary (CA)

Correspondence Address: PARLEE MCLAWS LLP, 1500 MANULIFE PLACE, 10180-101 STREET, EDMONTON, AB, T5J 4K1, US

(21) Appl. No.: 11/625,324

(22) Filed: Jan. 20, 2007

(30) Foreign Application Priority Data
Jun. 20, 2006 (CA) 2550793
Aug. 9, 2006 (CA) 2555668

(51) Int. Cl. F16K 35/00

(52) U.S. Cl. 137/384.2

(57) ABSTRACT

A system for restricting access to wellhead handwheel-actuated valves is provided. Two or more handwheels at a wellhead may be secured by engaging each handwheel with an engagement member and locking the engagement members together such that the handwheels may not be rotated. Each handwheel may be engaged in a manner that will also prevent unauthorized removal of each handwheel. The system provides versatility in that handwheels may be secured over a distance by use of a distance adjustment member, which is independently locked to each engagement member. A method for locking handwheel-actuated valves and related kit is also described.

### FIELD OF THE INVENTION

The present invention relates generally to devices that may be affixed to a wellhead. More particularly, the present invention relates to security devices for locking handwheel-actuated valves at a wellhead to deter unauthorized access to the valves.

### BACKGROUND OF THE INVENTION

As exploration for new oil and gas reserves has grown increasingly more competitive, companies have developed various intelligence strategies to obtain proprietary information regarding their competitors' production capabilities, strategies, and potential locations for exploration. In certain jurisdictions, legislation may provide a limited period of confidentiality to oil companies drilling exploratory wells. Such confidential information may be invaluable to a competitor, particularly when an exploratory well is located adjacent to saleable and/or unproven land. Covertly obtaining favourable information regarding the exploratory well of a competitor may allow the adjacent land to be purchased simply by outbidding the unsuspecting company who drilled the exploratory well.

Despite attempts by oil companies to maintain the confidentiality of their exploratory and active wellhead information, oil well scouts are frequently contracted by competitive oil companies to obtain intelligence regarding these wells. Requests for information may include wellhead pressure measurements, daily depths, penetration rates, formation pressures, drilling mud properties, flow pressures, gas flow rates, perforation intervals, and production potential estimates. Oil scouts obtain this information using many techniques, often including trespassing on company property by night and taking readings directly from the wellhead of interest.

When securing a wellhead, site engineers who are wary of scouting activity may remove the pressure gauges from the wellhead and replace them with threaded plugs to prevent scouts from simply reading and recording wellhead pressures therefrom. Scouts therefore carry a variety of tools and equipment, and may easily remove a threaded plug from an open port and insert a pressure gauge to take the desired reading.

Such trespassing by oilfield scouts not only causes companies to lose their competitive edge, but exposes the company to liability if the integrity of the wellhead is breached and a leak occurs. In addition, vandals have been known to tamper with wellheads, which may release sour gas into the atmosphere. The potential for release of sour gas from an oil or gas well poses a great hazard to oilfield personnel, particularly if the well is not properly secured and monitored. Thus, when exploring and flow-testing well sites that may potentially produce sour gas, some oil companies have eliminated the practice of providing on-site sleeping quarters for their site engineers, choosing instead to provide off-lease sleeping quarters. This creates an even greater need to provide adequate physical security measures on these unsupervised leases.

Oil companies have employed rudimentary measures such as chains and padlocks to secure their wellhead equipment from theft and to deter oil scouts and vandals, however these measures are easily circumvented simply by cutting a link in the chain to remove the chain and padlock from the wellhead. If the chain is removed from the wellhead, information may be gathered and the chain reconnected, leaving minimal evidence of tampering. Moreover, even when the wellhead master valve is secured with chains, scouts may remove the nut holding the master valve in place, lift off the master valve with the chain still intact, open the valve, unscrew the bull plug, and screw in their own pressure gauge to obtain pressure measurements. Thus, chains and padlocks do not sufficiently prevent information theft and therefore only provide a false sense of security. In fact, such rudimentary measures may cause more serious problems for the company owning the wellhead if such tampering causes a leak, as the leak would appear to be caused by the company's own personnel if evidence of tampering is not apparent. As such, current methods for securing wellheads do not deter tampering or information theft, and do not provide adequate security to oil companies.

Devices for locking a valve and/or handwheel have been described in the prior art, however, such devices may not be suitable ideal for use at a wellhead, where versatility and simplicity are required. Moreover, prior art valve locks are generally not universal, as each is suitable for use with a specific configuration of valve. Moreover, existing valve locks generally require modification to the valve stem or require removal of the valve wheel in order to assemble the lock around the valve.

In addition, prior art devices generally do not protect against removal of the nut securing the valve wheel. Thus, when used in the oil patch, scouts may simply remove the valve wheel to gain access to the valve.

U.S. Pat. No. 5,215,112 describes a locking bracket for a valve actuator. The bracket includes an extending arm for contacting a surface of the valve housing to prevent rotation of the handwheel. Removal of the handwheel is necessary in order to install and remove the bracket, and the device does not deter against removal of the handwheel and the device itself by a vandal or oil scout desiring access to the valve.

U.S. Pat. No. 4,397,332 describes a device for locking a standpipe cap, in which a bent metal bar is secured against the standpipe cap and may extend through the handwheel to cover the handwheel nut. The device prevents rotation of the handwheel as well as covering the nut securing the handwheel to prevent removal of same. The device must be secured to a standpipe or other similar stationary device, and is not adjustable or adaptable for use on valves of various sizes or configurations. Moreover, multiple handwheels must be individually secured, which may be time consuming.

U.S. patent application 2004/0144426 describes a device for installation about a gate valve to prevent rotation of the valve wheel. The device is inserted between vertical legs of the valve stem to limit rotation of the device. Such legs are not generally present on wellhead valves.

Valve covers have previously been disclosed in which two valves are covered and locked together to prevent removal of the covers. For example, U.S. Pat. No. 5,590,682 describes a rotation prevention device for hot and cold taps in which the hot and cold taps are covered and locked together to prevent rotation of either tap. Similarly, U.S. Pat. No. 6,068,020 describes a device for securing a dual gas feed line in which the dual gas line fittings are concealed by a two-part lockable device. Both of these inventions cover or limit access to the valve rather than simply limiting movement of the valve, and each must be custom-fitted for proper engagement with the appropriate tap or fitting, respectively.

In the field of oilfield security, individual locking of each valve wheel would be time consuming and cumbersome. Moreover, access to certain wellhead valves, for example casing valves, may be limited or may be surrounded or submerged in mud and/or water. Therefore, a simple locking device for quickly securing multiple wellhead valves in various wellhead configurations is desirable.

It is further desirable to secure wellhead valves in a manner that deters oil scouts from tampering.

### SUMMARY OF THE INVENTION

In accordance with a first aspect of the invention, there is provided a device for securing handwheel-actuated valves at a wellhead, comprising: a first wheel engagement member for engaging a first valve handwheel, the wheel engagement member having an extending portion for protruding towards a second valve handwheel when the first handwheel is engaged by the first wheel engagement member; a second wheel engagement member for engaging the second valve handwheel, the second wheel engagement member having an extending portion for protruding towards the first handwheel when the second handwheel is engaged by the second engagement member; and a locking system for locking the extending portion of the first engagement member to the extending portion of the second engagement member to limit movement of the first and second engagement members with respect to the first and second handwheels, thereby limiting operation of the first and second handwheel-actuated valves.

In an embodiment, the locking system comprises at least one locking aperture within the extending portion of each of the first and second engagement members; and padlock for insertion through the locking apertures when the locking apertures of the first and second engagement members are aligned.

In a further embodiment, the locking system comprises a distance adjustment member for independent locking to the extending portions of the first and second engagement members.

In a further embodiment, the extending portion of the first and second engagement members each bear a locking aperture, and the distance adjustment member includes a series of locking apertures along its length such that a padlock or cable may be inserted through the locking apertures of each engagement member and through appropriate locking apertures of the distance adjustment member to independently secure each engagement member to the distance adjustment member and limit movement of the first and second engagement members with respect to the handwheels, thereby limiting operation of the first and second handwheel-actuated valves.

In the above embodiments, the engagement members include either: a hook portion for engaging the rim of a handwheel between two spokes of the handwheel; or a threaded portion for fastening to the valve stem over the handwheel to secure the handwheel on the valve stem and to hinder operation of the handwheel.

In a second aspect of the invention, there is provided a method for securing handwheel-actuated valves at a wellhead comprising the steps of: engaging a first handwheel with an engagement portion of a first engagement member such that an extending portion of the first engagement member protrudes towards a second wellhead handwheel; engaging the second handwheel with an engagement portion of a second engagement member such that an extending portion of the second engagement member protrudes towards the first wellhead handwheel; and locking the protruding portions of the first and second engagement members together to limit movement of the engagement members with respect to the handwheels and thereby limit operation of the handwheel-actuated valves.

In an embodiment of this aspect of the invention, the step of locking the protruding portions of the first and second engagement members together comprises insertion of a padlock or cable through locking apertures within the protruding portions of the engagement members. Further, the engagement members are positioned on each handwheel such that the locking apertures of the first and second engagement members are substantially aligned.

In a further embodiment, the step of locking the protruding portions of the first and second engagement members together includes the step of locking a distance adjustment member to the extending portions of the first and second engagement members to span the distance between same and thereby limit operation of the handwheel-actuated valves.

In the above embodiment, the step of locking a distance adjustment member to the extending portions of the first and second engagement member may comprise: inserting a padlock or cable through a locking aperture of the first engagement member and through a first locking aperture in the distance adjustment member; and inserting a padlock or cable through a locking aperture of the second engagement member and through a second locking aperture in the distance adjustment member.

In a further embodiment, the first engagement member includes a hook portion and the first handwheel is engaged by the first engagement member by engaging the handwheel rim with the hook portion of the first engagement member.

In an alternate embodiment, the first engagement member includes a threaded end wherein the first handwheel is engaged by the first engagement member by threading the first engagement member onto the valve stem against the handwheel.

In a third aspect of the invention, there is provided a kit for securing handwheel-actuated valves at a wellhead comprising: two or more handwheel engagement members, each member having a handwheel engagement portion and an extending portion; and a locking system for locking the extending portions of each engagement member together.

In an embodiment of this aspect of the invention, the extending portion of each engagement member includes a locking aperture and the locking system comprises at least two padlocks.

In a further embodiment of the above, the engagement portion of at least one of the engagement members is a hook for engaging the rim of a handwheel.

In a further embodiment, the engagement portion of at least one of the engagement members is threaded for fastening to a valve stem against a handwheel.

The kit may further comprise a distance adjustment member for independent locking to the extending portions of each engagement member.

### BRIEF DESCRIPTION OF THE DRAWINGS

Embodiments of the present invention will now be described, by way of example only, with reference to the attached Figures, wherein:

FIG. 1 is a schematic of a typical wellhead as is known in the art;

FIG. 2 is a perspective view of a disassembled valve wheel lockup device in accordance with an embodiment of the invention;

FIG. 3 is a perspective view of the valve wheel lockup device of FIG. 2 shown assembled about two valve wheels in accordance with an embodiment of the invention;

FIG. 4 is a perspective view of a disassembled valve wheel lockup device in accordance with an embodiment of the invention, and;

FIG. 5 is a perspective view of the valve wheel lockup device of FIG. 4 shown in engagement with two valve wheels in accordance with an embodiment of the invention.

### DETAILED DESCRIPTION

Generally, the present invention provides a system for securing handwheel-actuated valves at oil and gas wellheads to prevent tampering and information theft therefrom. Specifically, the invention provides wheel engagement members for engaging individual valve wheels in close proximity at a wellhead, wherein two or more engagement members may be locked together to limit operation of respective handwheel-actuated valves.

Applicant's corresponding Canadian application CA 2,555,668 (the contents of which are incorporated herein by reference) describes a system for securing wellhead equipment, including a flexible cable for wrapping about wellhead equipment. The cable is secured with a cable restraint to prevent removal of the cable and tampering with wellhead equipment. The aforementioned system also includes device shields for shielding access to specific types of wellhead equipment, wherein the device shields are secured in place with the flexible cable and cable restraint. The present application describes additional devices for use in securing wellhead valve handwheels, which may also be used in conjunction with the earlier-described securing system.

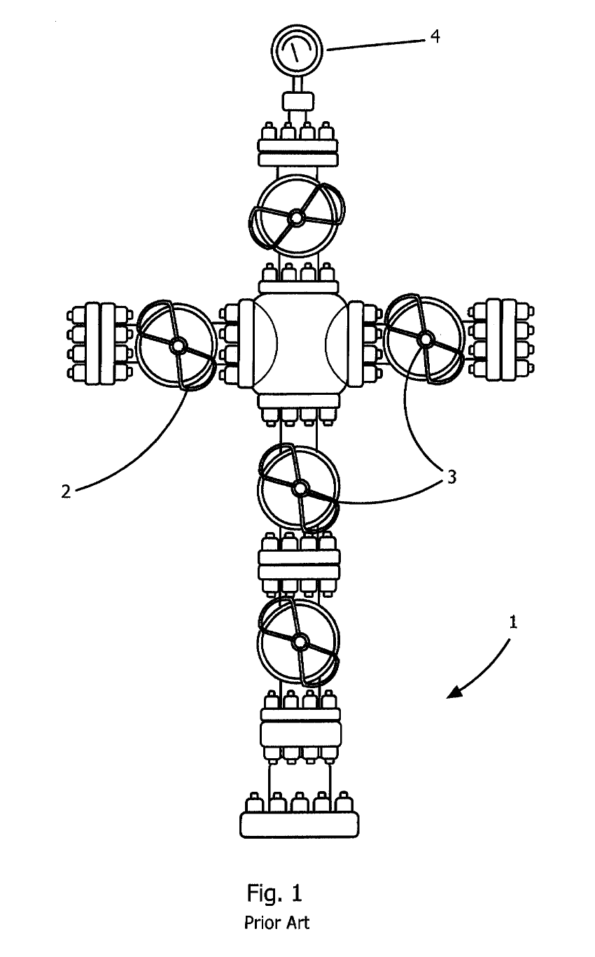

FIG. 1 presents a schematic drawing of a wellhead 1 fitted with typical wellhead equipment, including handwheel-actuated valves 2, bull plugs 3, and pressure gauge 4. When such equipment is fitted to a wellhead, any person may generally approach the wellhead and view or manipulate the equipment. As wellheads are often located in remote areas, such trespassing and tampering with wellhead equipment may be undetectable by the land or equipment owner.

### Overview

The wheel engagement members of the present invention engage a portion of a handwheel-actuated valve. At least two engagement members are used at any one wellhead such that two valves become dependently engaged. When locked together, the engagement members may not be removed or adjusted, limiting operation of the associated valves. It is preferable that when the engagement members are locked together, with or without use of a distance adjustment member (as will be described below), the handwheels become inoperable or difficult to operate. In addition, the handwheels may be locked upon their respective valve stems to prevent unauthorized removal therefrom. It should be noted that different applications and wellhead locations may require different security measures, and appropriate devices may be selected and affixed to appropriate valves at a wellhead in accordance with the invention, in a manner determined by the site engineer or security manager.

The engagement members, when properly used, secure the position of each valve handwheel. The engagement members may physically contact the rim or spokes of a handwheel to interfere with wheel rotation, or the members may be affixed to the valve stem over the handwheel to prevent removal of the handwheel, thereby engaging the handwheel against the valve stem. Once two handwheels are so engaged by the engagement members of the present invention and the engagement members are locked together, operation of the valve limited, either by substantially preventing rotation of the handwheel, or by creating a physical barrier that interferes with rotation of the handwheel such that operation of the valve is difficult or laborious.

### Locking Devices Having a Hook Member

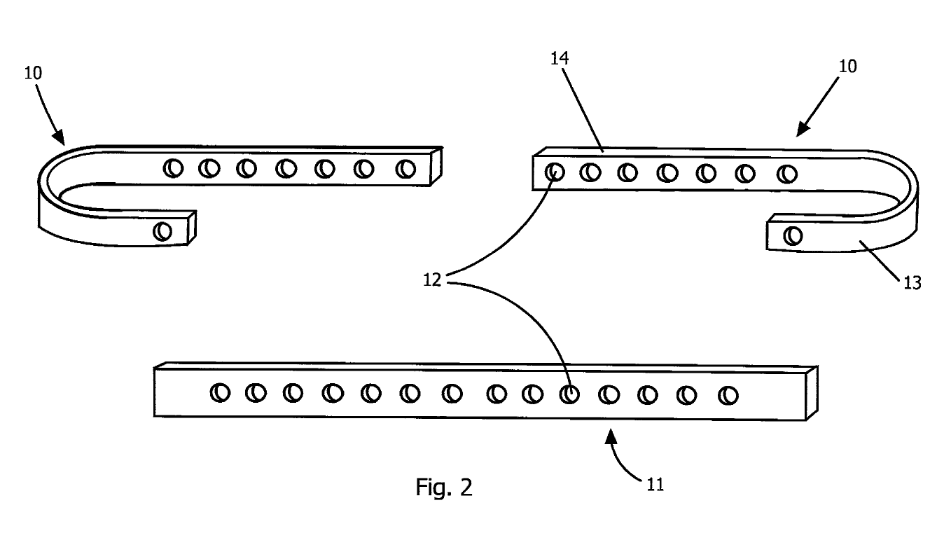

In the embodiment of the invention shown in FIG. 2, wheel engagement members 10, each having a hook portion 13 and an extending portion 14, are provided for engaging the rim of each valve handwheel 5, and the engagement members may be locked together to limit operation of the handwheels 5. At least one distance adjustment member 11 are also present for adjustable attachment to each engagement member 10 as necessary. In the embodiment shown, the engagement members 10 each include locking apertures 12, and distance adjustment member 11 similarly includes a series of locking apertures 12 for receiving a padlock or cable to secure the distance adjustment member to the extending portion of each engagement member.

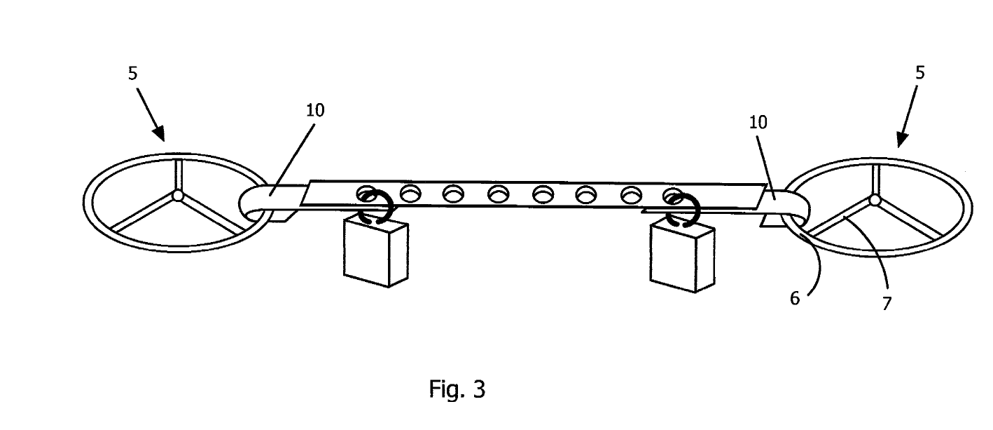

In use, as shown in FIG. 3, two wellhead handwheels 5 in relative proximity are selected for locking together using the engagement members. An engagement member 10 is applied to the first wellhead handwheel 5 with the hook-member 13 placed around the inside of the rim 6 of the handwheel between two handwheel spokes 7, with the extending portion 14 of the engagement member protruding outwardly towards the second handwheel. A separate engagement member 10 is similarly applied to the second handwheel. If the extending portions of the engagement members overlap, the engagement members may be locked together by inserting a padlock or cable through the locking aperture 12 of each member 10. Alternatively, one or more distance adjustment members may be used to connect the engagement members 10 by insertion of a padlock or cable through the locking apertures in the engagement members and distance adjustment member.

### Locking Devices Having a Threaded Portion

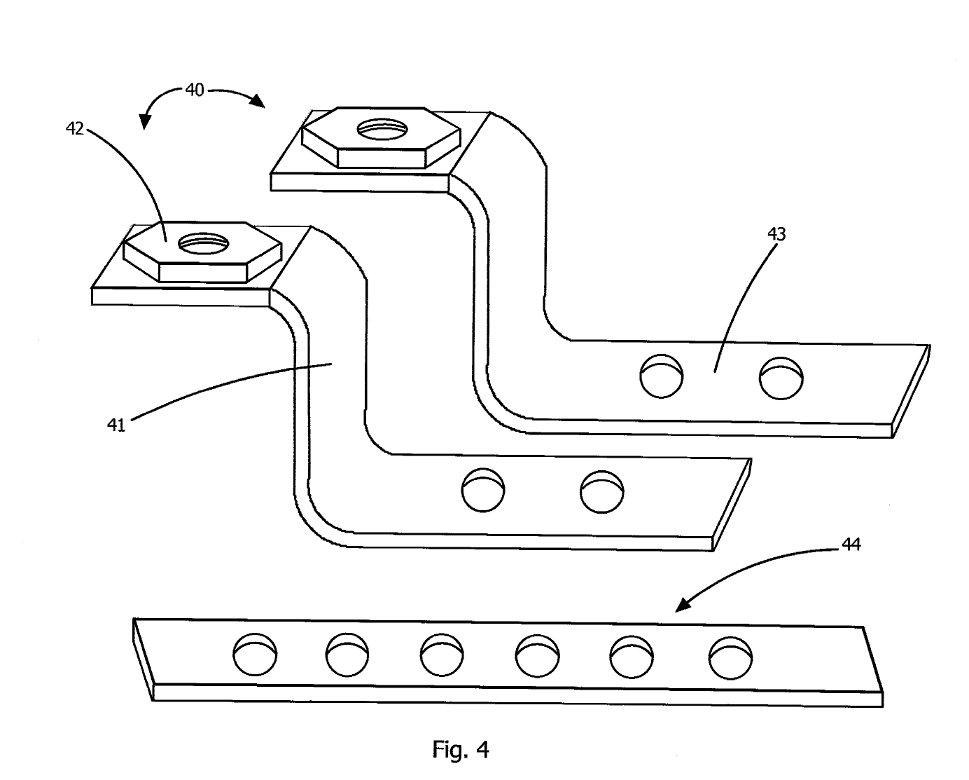

In an alternate embodiment, as shown in FIG. 4, engagement members 40 do not include a hook-member, but instead include an angled portion 41 having a threaded end 42. The engagement member 40 is threaded onto the valve stem over the handwheel, engaging the handwheel upon the valve stem. The extending portion 43 of two such engagement members are locked together, with or without using one or more additional distance adjustment members 44. Once locked together, the engagement members cannot be rotated and removed from the valve stem, preventing removal of the handwheels. In addition, the locked extending portions of the engagement members create a physical hindrance to unauthorized users attempting to rotate either handwheel.

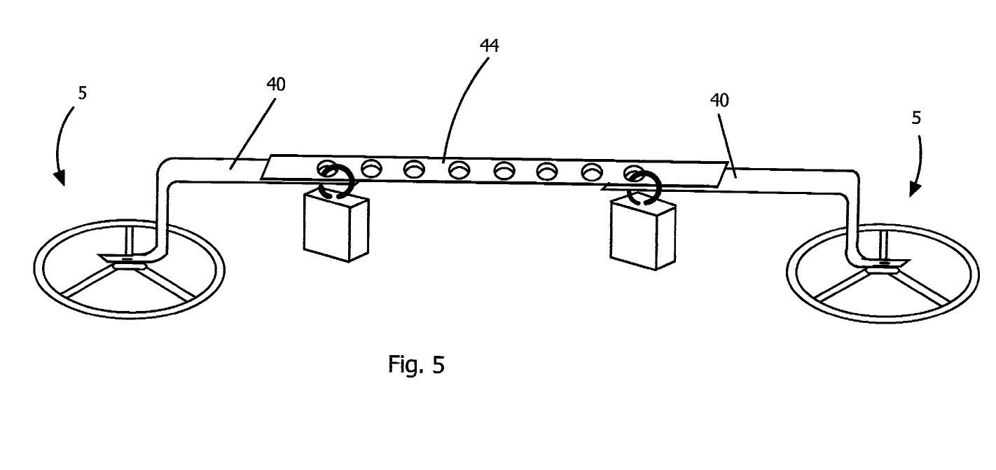

In use, two wellhead handwheels in relative proximity are selected for locking together using the engagement members 40. The securing nut is removed from the first handwheel, and the threaded end 42 of an engagement member 40 is threaded onto the valve stem with the extending portion 43 of the engagement member 40 protruding outwardly over the first handwheel towards the second handwheel. A separate engagement member 40 is similarly applied to the second handwheel. If the extending portions 43 of the engagement members 40 overlap, the engagement members 40 may be locked together by inserting a padlock or cable through the locking aperture 45 of each member 10. Alternatively, as shown in FIG. 5, one or more distance adjustment members may be used to connect the engagement members 40, thereby preventing removal of the handwheels 5 and creating a physical barrier to unauthorized users attempting to gain access to the valve.

In an embodiment, the extending portion 43 of the engagement members 40 protrudes above the handwheel rim, while a distance adjustment member may extend between the handwheels below the handwheel rims. The distance adjustment member is then connected to the engagement members using a large padlock or cable placed inside the handwheel rim between the handwheel spokes. Such a connection will secure the handwheels upon respective valve stems while further creating a barrier between the spokes of each handwheel, thus limiting rotation of the handwheels and also preventing unauthorized valve access.

### Distance Adjustment Member

The distance adjustment member shown in FIGS. 2 through 5 is an example of a simple distance adjustment member that may be used in accordance with certain embodiments of the invention. The distance adjustment member shown includes a series of locking apertures along its length to provide versatility in locking together engagement members over a variety of distances. Such a distance adjustment member may be any appropriate length, and may include any number of locking apertures, through which a cable or padlock may be inserted to lock the distance adjustment member to an engagement member.

Other suitable engagement members may be designed, constructed, and used in accordance with the invention. For example, the distance adjustment member may be a telescopic rod for connection to each engagement member, or a cable for threading through locking apertures in each engagement member.

As the purpose of the distance adjustment member is to lock a first engagement member with a second engagement member to limit movement of the engagement members with respect to their engaged valves, it is preferable that the distance adjustment member be constructed of rigid material such as steel. Although the distance adjustment member is used primarily when the extending portions of the first and second engagement members do not overlap, it may also be used when the extending portions of the engagement members do overlap, adding strength to the system.

Notably, when the engagement members each include an angled portion and threaded end, as shown in FIGS. 4 and 5, the distance adjustment member may be used to further limit operation of the handwheel by placement beneath the rim of the handwheel, with a padlock or cable extending through the distance adjustment member, inside the rim of the handwheel between two handwheel spokes, and through a portion of the engagement member. In this configuration, a great degree of security is provided, as the distance adjustment member and padlock or cable act as a barrier between the handwheel spokes to prevent operation of the valve, while the engagement member with its threaded end may not be removed from the valve stem to remove the handwheel.

### Methods to Make Security Devices

The above security devices are preferably formed by welding together pieces of steel. Preferably, the devices are formed from steel lengths that are 1½″ wide and ⅜″ thick, although a multitude of other suitable dimensions may be used, as will be readily appreciated by those skilled in the art. It is contemplated that the devices may be custom built on-site, however it is generally not recommended to do so as specific regulations are typically imposed upon drilling and production sites to minimize the potential for hazardous occurrences. Generally, devices that may produce significant heat or sparks are therefore not permitted at wellhead locations.

Although the security devices described herein remain subject to removal by an oil scout or vandal by cutting steel, cable or padlocks, the devices provide a valuable deterrent against oil scouts, as such tampering would be immediately evident to the site engineer on daily inspection of the wellhead, and appropriate security detail could be implemented to prevent further tampering or to apprehend trespassers. Moreover, in the event of an oil or gas leak or explosion, the company owning the wellhead equipment would have evidence to indicate that appropriate security measures were in place, and to confirm that vandalism, and not negligence, caused the incident.

### Method/Kit for Securing a Wellhead

An embodiment of a method for securing a wellhead includes providing the valve handwheel engagement members with or without distance adjustment members to a user desirous of securing handwheel-actuated valves at a wellhead.

It should be noted that the present system of locking equipment at a wellhead provides a significant degree of flexibility to the user. For example, virtually any two handwheel-actuated valves at a single wellhead may be secured in accordance with the invention, using an appropriate number of distance adjustment members and padlocks and/or cables. Moreover, if each set of devices is locked with a separately keyed padlock, selective access to each set of valves may be provided to specific individuals simply by providing these individuals with an appropriate set of keys. A customized access system may also be implemented, in which the site engineer has a master key to lock up the entire wellhead, while flow testers may be given a key which only opens the padlock securing the flow valves.

It should be noted that although the present description refers to the use of padlocks to secure each device, many other locking mechanisms could be used to secure each device, including electronic keying, biometric verification, smartcards, or keypad access to each device.

In an embodiment of the invention, a kit is provided for securing wellhead equipment at a wellhead. The kit minimally includes two engagement members. It is contemplated that the user may desire to secure two handwheels using different types of engagement members. For example, the user may secure one handwheel with a hook-type engagement member, and the other with a threaded end-type engagement member. The user may or may not require distance adjustment members. Moreover, the user may secure the same set of handwheels with both types of engagement members to further secure the handwheel and valve. For example, the hook-type engagement member may be used to prevent rotation of the handwheel, while the threaded engagement member may be used to prevent removal of the handwheel. Accordingly, in a preferred embodiment of a wellhead securing kit, at least two of each type of engagement member are provided, as well as at least one distance adjustment member. The kit may also include lengths of cable and padlocks, as well as instructions for using the above items in securing wellhead equipment.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A device for securing handwheel-actuated valves at a wellhead, comprising:
a first wheel engagement member for engaging a first valve handwheel, the wheel engagement member having an extending portion for protruding towards a second valve handwheel when the first handwheel is engaged by the first wheel engagement member;
a second wheel engagement member for engaging the second valve handwheel, the second wheel engagement member having an extending portion for protruding towards the first handwheel when the second handwheel is engaged by the second engagement member; and
a locking system for locking the extending portion of the first engagement member to the extending portion of the second engagement member to limit movement of the first and second engagement members with respect to the first and second handwheels, thereby limiting operation of the first and second handwheel-actuated valves.

2. The device as in claim 1 wherein the locking system comprises at least one locking aperture within the extending portion of each of the first and second engagement members; and padlock for insertion through the locking apertures when the locking apertures of the first and second engagement members are aligned.

3. The device as in claim 1 wherein the locking system comprises a distance adjustment member for independent locking to the extending portions of the first and second engagement members.

4. The device as in claim 4 wherein the extending portion of the first and second engagement members each bear a locking aperture, and wherein the distance adjustment member includes a series of locking apertures along its length such that a padlock or cable may be inserted through the locking apertures of each engagement member and through appropriate locking apertures of the distance adjustment member to independently secure each engagement member to the distance adjustment member and limit movement of the first and second engagement members with respect to the handwheels, thereby limiting operation of the first and second handwheel-actuated valves.

5. The device as in claim 1 wherein each engagement member includes a hook portion for engaging the rim of a handwheel between two spokes of the handwheel.

6. The device as in claim 1 wherein each engagement member includes a threaded portion for fastening to the valve stem over the handwheel to hinder operation of the handwheel.

7. A method for securing handwheel-actuated valves at a wellhead comprising the steps of:
engaging a first handwheel with an engagement portion of a first engagement member such that an extending portion of the first engagement member protrudes towards a second wellhead handwheel;
engaging the second handwheel with an engagement portion of a second engagement member such that an extending portion of the second engagement member protrudes towards the first wellhead handwheel;
locking the protruding portions of the first and second engagement members together to limit movement of the engagement members with respect to the handwheels and thereby limit operation of the handwheel-actuated valves.

8. The method as in claim 7 wherein the step of locking the protruding portions of the first and second engagement members together comprises insertion of a padlock or cable through locking apertures within the protruding portions of the engagement members.

9. The method as in claim 8 wherein the engagement members are positioned on each handwheel such that the locking apertures of the first and second engagement members are substantially aligned.

10. The method as in claim 7 wherein the step of locking the protruding portions of the first and second engagement members together includes the step of locking a distance adjustment member to the extending portions of the first and second engagement members to span the distance between same and thereby limit operation of the handwheel-actuated valves.

11. The method as in claim 10 wherein the step of locking a distance adjustment member to the extending portions of the first and second engagement member comprises:
inserting a padlock or cable through a locking aperture of the first engagement member and through a first locking aperture in the distance adjustment member: and
inserting a padlock or cable through a locking aperture of the second engagement member and through a second locking aperture in the distance adjustment member.

12. The method as in claim 8 wherein the first engagement member includes a hook portion and wherein the first handwheel is engaged by the first engagement member by engaging the handwheel rim with the hook portion of the first engagement member.

13. The method as in claims 8 wherein the first engagement member includes a threaded end wherein the first handwheel is engaged by the first engagement member by threading the first engagement member onto the valve stem against the handwheel.

14. A kit for securing handwheel-actuated valves at a wellhead comprising:
two or more handwheel engagement members, each member having a handwheel engagement portion and an extending portion; and
a locking system for locking the extending portions of each engagement member together.

15. The kit as in claim 14 wherein the extending portion of each engagement member includes a locking aperture and wherein the locking system comprises at least two padlocks.

16. The kit as in claim 14 wherein the engagement portion of at least one of the engagement members is a hook for engaging the rim of a handwheel.

17. The kit as in claim 14 wherein the engagement portion of at least one of the engagement members is threaded for fastening to a valve stem against a handwheel.

18. The kit as in claim 14 further comprising a distance adjustment member for independent locking to the extending portions of each engagement member.
